(19) United States
(12) Patent Application Publication
(10) Pub. No.: US 2009/0028982 A1
(43) Pub. Date: Jan. 29, 2009

(54) EXTRUSION DIE FOR MOLDING HONEYCOMB STRUCTURES

(75) Inventor: Tadanobu ASAOKA, Takahama-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/174,998

(22) Filed: Jul. 17, 2008

(30) Foreign Application Priority Data
Jul. 24, 2007 (JP) 2007-191778

(51) Int. Cl. B28B 21/52

(52) U.S. Cl. 425/464

(57) ABSTRACT

An extrusion die for use of producing a honeycomb structure composed of cells surrounded by cell walls and an outer peripheral skin. The extrusion die has a die body part and a guide ring. Feeding holes and corresponding slit grooves are formed in the die body part. The guide ring has a pole part and a guide part. The specified feeding holes which are not correspond to any slit grooves are formed in the outside area of a slit groove formation area in the die body part. Through the specified feeding holes, raw material is fed in order to make the outer peripheral skin. The specified feeding holes are arranged in one or more ring-shaped rows. Each specified feeding hole in each ring-shaped row has a same distance to the front end of the guide part in the direction vertical to the extrusion direction of the raw material.

### CROSS-REFERENCE TO RELATED APPLICATION

This application is related to and claims priority from Japanese Patent Application No. 2007-191778 filed on Jul. 24, 2007, the contents of which are hereby incorporated by reference.

### BACKGROUND OF THE INVENTION

1. Field of the Invention

The present invention relates to an extrusion die for molding a honeycomb structure by extruding ceramic raw material.

2. Description of the Related Art

There have been widely known a catalyst support on which is supported. The catalyst support having the catalyst is capable of purifying specific components such as nitride oxide (NOx) contained in exhaust gas emitted from an internal combustion engine such as a diesel engine.

FIG. 6 is a perspective view of a honeycomb structure 8 as a final product which has been produced using an extrusion die. In general, the honeycomb structure 8 is comprised of a plurality of cell walls 81, a plurality of cells 82 surrounded by the cell walls 81, and an outer peripheral skin 83 of a cylindrical shape. The cell walls 81 are covered with this outer peripheral skin 83. As shown in FIG. 6, the cell walls 81 are arranged in a honeycomb shape. The cell walls 81 form the cells 82. For example, a square shape cell us surrounded by the four cell walls 81.

The honeycomb structure 8 shown in FIG. 6 is generally produced by using an extrusion die. Ceramic raw material is extruded through the extrusion die in order to make a green body made of ceramic. The green body is then dried and fired in order to produce the honeycomb structure 8 as a final product.

There are various types of conventional extrusion dies in order to extrude a ceramic green body corresponding to the honeycomb structure. For example, Japanese patent laid open publication NO. JP 2002-283326 discloses a conventional extrusion die as shown in FIG. 10.

FIG. 10 is an explanatory view showing a cross section of a conventional extrusion die 91 and an extrusion process of making an outer peripheral skin 83 and cell walls 81 of a honeycomb structure using the conventional extrusion die.

As shown in FIG. 10, the extrusion die 91 for making a honeycomb structure is comprised of a die body part 92 and a guide ring 95. The die body part 92 is composed of a plurality of feeding holes 931 and a plurality of slit groove 941. Raw material 80 is fed into the slit grooves 941 from the feeding holes 931 of the extrusion die 91. The slit grooves 941 are arranged in a honeycomb arrangement, and a part of the slit grooves 941 faces the inner surface of the guide ring 95.

The raw material 80 fed through the feeding holes 931 is extruded through the slit grooves 941 in order to mold a honeycomb structure. The guide ring 95 guides the raw material 80 extruded through a part of the slit groove 941 in order to make the outer peripheral skin 83 of the honeycomb structure.

As shown in FIG. 10, on extruding the raw material 80 using the extrusion die 91 having the above structure, a part of the raw material 80 extruded in the extrusion direction from a part of the slit grooves 941 flows into the gap 910 between the die body part 92 and the guide ring 95. The raw material 80 fed in the gap 910 flows toward the central part of the die body part 92. The raw material 80 in the gap 910 is then guided at the front end 951 of the guide ring 95, and finally forms the outer peripheral skin 83 of the honeycomb structure.

As shown in FIG. 10, a part of the raw material 80 which forms the outer peripheral skin 83 is extruded and fed into the guide ring 95 through a part of the slit grooves 941 which face the guide ring 95. For example, the feeding holes 931 communicated with the slit grooves 941 are formed at the lattice points in a lattice structure of the slit grooves 941. Accordingly, each feeding hole 931 has a different distance to the front end 951 of the guide ring 95. Such a structure of the feeding holes 931 in the extrusion die 91 would cause a problem in which the feeding holes 931 having a short distance to the front end 951 of the guide ring 95 provides a large amount of the raw material 80 in making the outer peripheral skin 83. This leads to an overly thick outer peripheral skin 83 of the honeycomb structure being produced.

On the other hand, the feeding holes 931 having a long distance to the front end 951 of the guide ring 95 provide less amount of the raw material 80 to make the outer peripheral skin 83. The structure of the conventional extrusion die 91 leads to make an overly thin outer peripheral skin 83 of the honeycomb structure being produced.

That is, in the structure of the conventional extrusion die 91, the amount of the raw material 80 to be supplied from each slit groove 941 to the front end 951 of the guide ring 95 in order to make the outer peripheral skin 82 is varied. As a result, the conventional extrusion die 91 produces the honeycomb structure 8 with the outer peripheral skin 83 of non-uniform thickness. When the honeycomb structure 8 with the outer peripheral skin 83 of non-uniform thickness is mounted to an exhaust gas purifying system for an internal combustion engine such as a diesel engine and then used at a high temperature under exhaust-gas environment, thermal shock is applied to the honeycomb structure 8 and different thermal stresses are generated at those different thickness parts of the outer peripheral skin 83. Those different thermal stresses would cause a deterioration of thermal shock resistance of the honeycomb structure S.

### SUMMARY OF THE INVENTION

It is an object of the present invention to provide an extrusion die capable of molding a honeycomb structure having an outer peripheral skin part of a uniform thickness with high thermal shock resistance. The extrusion die according to the present invention is capable of making the outer peripheral skin of a honeycomb structure with very few variations in thickness.

To achieve the above purposes, the present invention provides an extrusion die to be used for producing a honeycomb structure. The extrusion die is comprised of a plurality of cell walls arranged in a honeycomb shape, a plurality of cells surrounded by the cell walls, and an outer peripheral skin covering an outer peripheral surface of the honeycomb structure. The extrusion die makes the cell walls and the outer peripheral skin as one body. The extrusion die has a die body part and a guide ring. In particular, the die body part has a primary formation area and a secondary formation area. In the primary formation area, primary feeding holes and slit grooves arranged in a lattice shape are formed. Those feeding holes communicate with the slit grooves. Raw material is fed from the primary feeding holes into the slit grooves which are correspondingly communicated with the primary feeding holes. In the secondary formation area which is placed in the outside of the primary formation area of the die body part. In the secondary formation area, a plurality of secondary feeding holes is formed in at least one or more ring shaped rows. Through the secondary feeding holes, raw material is fed in order to form the outer peripheral skin. Each secondary feeding hole in each ring-shaped row has the same length, in a direction vertical to the extrusion direction of the raw material, which is measured from each secondary feeding hole to a front end of the guide ring. The guide ring is comprised of a pole part and a guide part. The pole part is formed on the die body part so that it projects in the extrusion direction of the raw material in the extrusion die. The guide part is formed from the pole part toward in an inside direction of the die body part so that a gap is formed between the guide part and the die body part.

In the die body part in the extrusion die according to the present invention, the secondary formation area is formed in the outside of the primary formation area so that the secondary formation area surrounds the primary formation area. In the secondary formation area, the secondary feeding holes are formed in at least one or more ring-shaped rows. Through the secondary feeding holes, the raw material to be used only for making the outer peripheral skin is supplied. That is, the structure of the extrusion die according to the present invention, the raw material to be used for making the outer peripheral skin is mainly supplied through the secondary feeding holes in the secondary formation area.

In particular, the extrusion die according to the present invention is so formed that each secondary feeding hole in each ring-shaped row has the same distance, in the direction vertical to the extrusion direction of the raw material, measured from each secondary feeding hole to the front end of the guide part of the guide ring.

When the honeycomb structure is produced using the extrusion die, the raw material can reach the front end of the guide part of the guide ring from each secondary feeding hole in each ring-shaped row by an equidistant movement. The outer peripheral skin is thereby made at the front end of the guide part using the raw material. In other words, the structure of the extrusion die according to the present invention enables that each secondary feeding hole in each ring-shaped row supplies the same amount of raw material to the front end of the guide part of the guide ring. It is thereby possible to suppress variation of the raw material in order to make the outer peripheral skin, and possible to form the honeycomb structure with the outer peripheral skin of a uniform thickness.

Using the extrusion die according to the present invention having the above structure can provide the honeycomb structures with the outer peripheral skin of a uniform thickness which can guarantee the quality of a superior thermal shock resistance and small variation to thermal stress generated by thermal shock.

### BRIEF DESCRIPTION OF THE DRAWINGS

A preferred, non-limiting embodiment of the present invention will be described by way of example with reference to the accompanying drawings, in which:

FIG. 1 is an explanatory view showing an extrusion die for molding a honeycomb structure according to a first embodiment of the present invention;

FIG. 2 is a cross section of the extrusion die along A-A line in FIG. 1;

FIG. 3A and FIG. 3B each is an explanatory view showing a die body part of the extrusion die according to the first embodiment shown in FIG. 1;

FIG. 4A to FIG. 4D each is an explanatory view showing a structural relationship between feeding holes and slit grooves formed in the die body part in the extrusion die according to the first embodiment shown in FIG. 1;

FIG. 5 is an explanatory view showing a process of extruding raw material in order to mold a honeycomb structure by using the extrusion die according to the first embodiment shown in FIG. 1;

FIG. 6 is a perspective view of the honeycomb structure, as a final product, which has been produced by using the extrusion die according to the first embodiment shown in FIG. 1;

FIG. 7 is an explanatory view showing an extrusion die for molding a honeycomb structure according to a second embodiment of the present invention;

FIG. 8 is an explanatory view showing an extrusion die for molding a honeycomb structure according to a third embodiment of the present invention;

FIG. 9 is an explanatory view showing a process of extruding raw material in order to mold a honeycomb structure by using the extrusion die according to the third embodiment shown in FIG. 8; and

FIG. 10 is an explanatory view showing a structure of a conventional extrusion die and an extrusion process of making an outer peripheral skin and cell walls of a honeycomb structure using the conventional extrusion die.

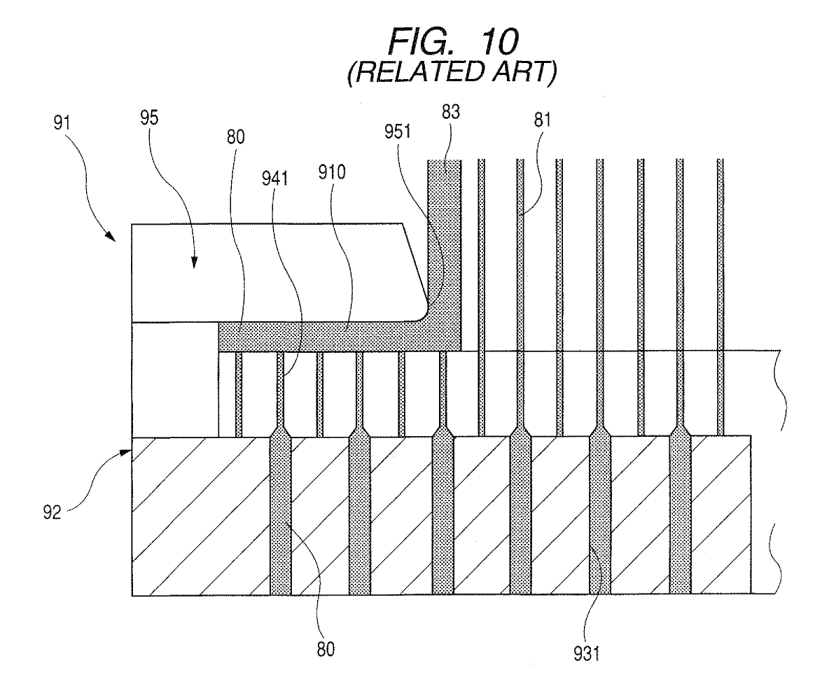

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Embodiment

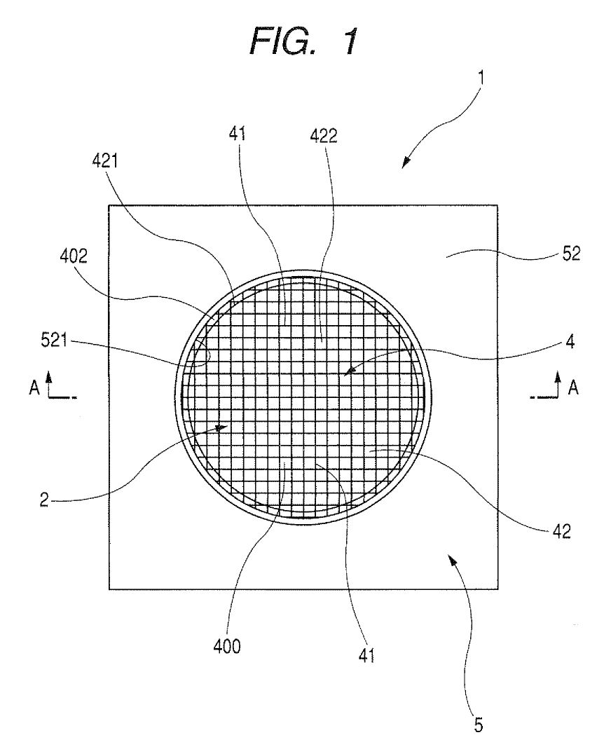

A description will be given of an extrusion die 1 according to the first embodiment with reference to FIG. 1 to FIG. 6.

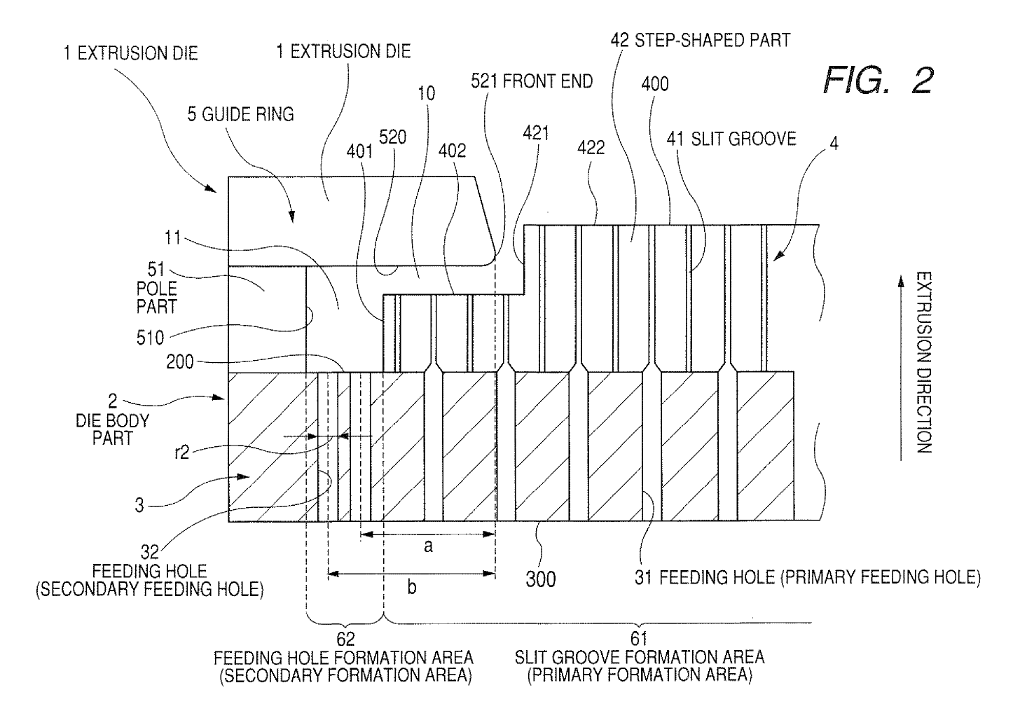

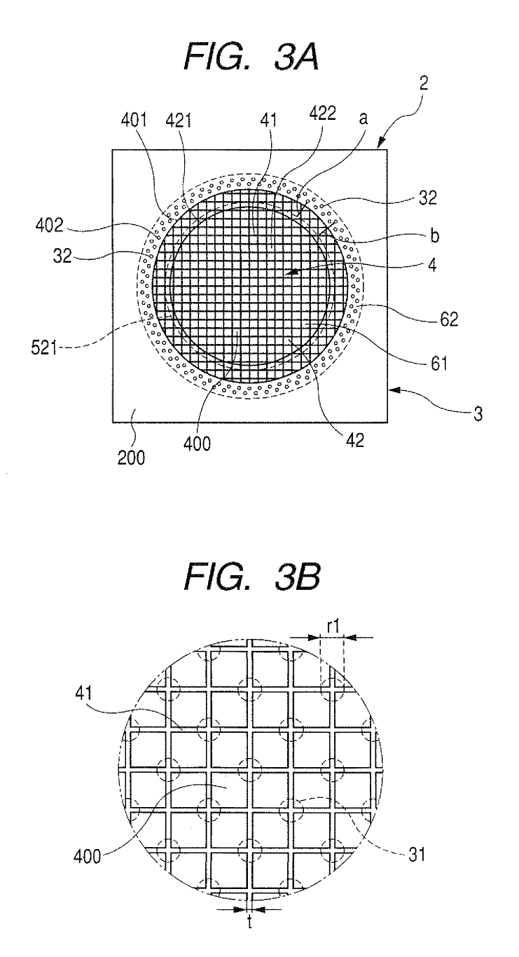

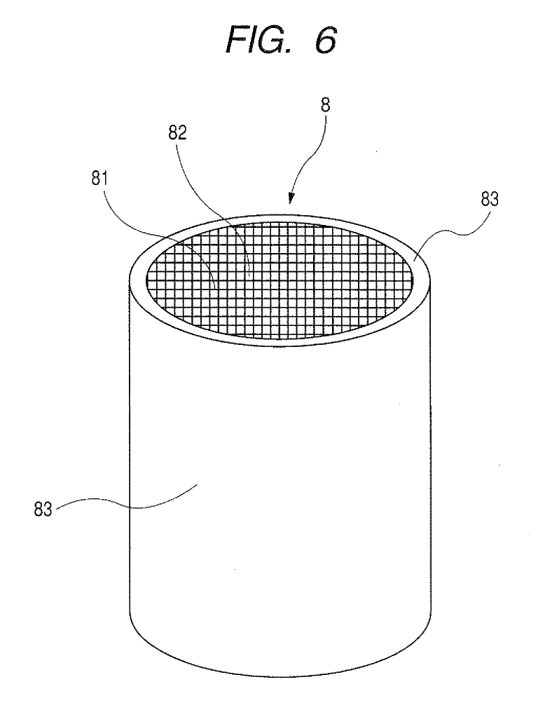

FIG. 1 is an explanatory view showing the extrusion die 1 to be used for molding a honeycomb structure 8 (see FIG. 6) according to the first embodiment. FIG. 2 is a cross section of the extrusion die 1 along A-A line in FIG. 1. FIG. 3A and FIG. 3B, each is an explanatory view showing a die body part 2 of the extrusion die 1 according to the first embodiment shown in FIG. 1.

As shown in FIG. 1, FIG. 2, and FIG. 3A and FIG. 3B, the extrusion die 1 is used for molding the honeycomb structure 8 shown in FIG. 6. The honeycomb structure 8 is comprised of a plurality of cell walls 81, a plurality of cells 82 surrounded by the cell walls 81, and an outer peripheral skin 83 of a cylindrical shape which covers the outer peripheral surface of the cell 82 of the honeycomb structure 8. The cell walls 81 are arranged in a honeycomb shape in order to form the cells 82.

As shown in FIG. 1 and FIG. 2, the extrusion die 1 is composed mainly of the die body part 2 and a guide ring 5.

The die body part 2 has pin holes (not shown) through which the guide ring 5 is fixed. The guide ring 5 also has pin holes (not shown) through which the die body part 2 is fixed together.

The die body part 2 has a feeding hole part 3 and a slit groove part 4. Feeding holes 31 (as primary feeding holes) are formed in the feeding hole part 3. Ceramic raw material is fed in the extrusion direction into the slit grooves 41 from the feeding holes 31. The slit grooves 41 are arranged in a square lattice shape, namely, a honeycomb shape. Through the slit grooves 41, the ceramic raw material fed from the feeding holes 31 is extruded and 10 molded into the honeycomb structure 8.

As shown in FIG. 2 and FIG. 3A, the slit groove part 4 having the slit grooves 41 is a circular shaped part which projects from the surrounding part in the die body part 2. The surrounding part surrounds the slit groove part 4 of a circular shape in the die body part 2. The slit grooves 41 are formed in a slit groove formation surface 400 of the slit groove part 4. Each slit groove 41 has a square shape. The slit grooves 41 are arranged in a square lattice shape.

As will be explained later, a circular step-shaped part 42 is formed in the slit groove formation surface 400. The circular step-shaped part 42 is formed in the area which does not face a guide part 52. The guide part 52 will be explained in detail later.

The circular step-shaped part 42 projects in the extrusion direction to which the ceramic raw material is fed. The slit groove formation surface 400 has a central slit groove formation surface 422 and an outer peripheral slit groove formation surface 402. The central slit groove formation surface 422 is formed in the circular step-shaped part 42. The outer peripheral slit groove formation surface 402 is formed in the area other then the circular step-shaped part 42 in the slit groove part 4.

As shown in FIG. 2, the feeding hole part 3 has the feeding holes 31 30 formed in the feeding hole formation surface 300 (which is the opposite surface of the slit groove formation surface 400). The feeding holes 31 are communicated with the slit grooves 41.

As shown in FIG. 3B, each of the feeding holes 31 is formed at the position which corresponds to an alternate lattice point in vertical and lateral directions in the lattice points of the slit grooves 41. Specifically, the inner diameter “r1” of each feeding hole 31 is 1.5 mm, and a groove width “t” of each slit groove 41 is 100 μm.

As shown in FIG. 1 and FIG. 2, the guide ring 5 has a pole part 51 and a guide part 52. The pole part 51 is extended from a reference surface 200 of the die body part 2 in the extrusion direction of ceramic raw material (hereinafter, referred to as the “extrusion direction”). The guide part 52 is projected from the pole part 51 toward the inside of the die body part 2 so that a gap 10 is formed between the guide part 52 and the slit groove part 4.

The pole part 51 has a ring shape. The pole part 51 is higher in the extrusion direction than the outer peripheral slit groove formation surface 402 in the slit groove part 4, so that the gap 10 is formed between them.

A raw material feeding path 11 is formed between the inner peripheral surface 510 of the pole part 51 and the outer peripheral surface 401 of the slit groove part 4 in the die body part 2. The raw material feeding path 11 feeds the ceramic raw material which is fed through feeding holes 32 (as secondary feeding holes) in order to make the outer peripheral skin 83.

The guide part 52 is composed of a guide surface 520 which faces an outer peripheral slit groove formation surface 402 of the slit groove part 4. The guide surface 520 projects toward the inside of the die body part 2 so that the guide surface 520 maintains a gap 10 formed between the guide surface 520 and the outer peripheral slit groove formation surface 402.

The front end 521 of the guide part 52 is a circular shape corresponding to a dimension of the outline of the honeycomb structure 8 to be produced. A gap is formed between the front end 521 of the guide part 52 and an outer peripheral side surface 421 of the circular step-shaped part 42. This gap has a predetermined dimension which corresponds to the thickness of the outer peripheral skin 83 to be formed on the outer surface of the cell walls of the honeycomb structure.

As shown in FIG. 2 and FIG. 3A, the die body part 2 according to the first embodiment has a feeding hole formation area 62 (as a secondary formation area) having the feeding holes 32 (as the secondary feeding holes) through which the ceramic raw material is supplied in order to make the outer peripheral skin 83. The feeding hole formation area 62 is formed in the outside area of the slit groove formation area 61 (as a primary formation area) in the die body part 2. This slit groove formation area 61 includes the slit groove formation surface 400. The slit grooves 41 are formed in the slit groove formation area 61. It is so formed that the feeding hole formation area 62 surrounds the slit groove formation area 61.

The plurality of feeding holes 32 are formed in the feeding hole formation area 62. The feeding holes 32 penetrate in the die body part 2. Through the feeding holes 32, ceramic raw material is supplied in order to form the outer peripheral skin 83.

The feeding holes 32 are formed in two ring-shaped rows (as a primary row and a secondary row) in the feeding hole formation area 62. The inner diameter “r2” of the feeding hole 32 is 1.5 mm.

It is preferable that the inner diameter “r2” of each feeding hole 32 is within a range of 0.7 mm to 1.8 mm.

Each feeding hole 32 in each row in the feeding hole formation area 62 has a same lateral-length which is measured in a vertical direction to the 25 extrusion direction of the ceramic raw material from the front end 521 of the guide part 52 to the position corresponding to each feeding hole 32.

That is, in the structure of the die body part 2 according to the first embodiment, as shown in FIG. 2, the shortest length “a” is 7.0 mm, which is measured from the center of each feeding hole 32 in the primary row to the front end 521 of the guide part 52. On the other hand, the shortest length “b” is 10.0 mm, which is measured from the center of each feeding hole 32 in the secondary row (the outside row) to the front end 521 of the guide part 52.

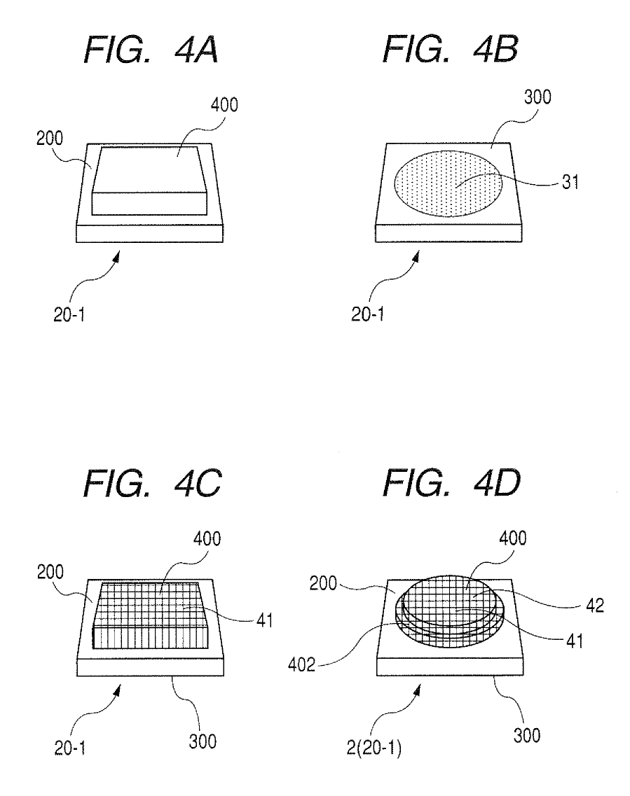

Next, a description will now be given of the method of producing the extrusion die 1 comprised of the die body part 2 and the guide ring 5 according to the first embodiment with reference to FIG. 4A to FIG. 4D.

FIG. 4A to FIG. 4D each is an explanatory view showing a structural relationship between the feeding holes 31, 32 and the slit grooves 41 formed in the die body part 2 in the extrusion die 1 according to the first embodiment shown in FIG. 1.

First, a square metal plate made of SKD61 is prepared as a die member 20-1. SK61 is an alloy tool steel for making die in Japanese Industrial Standards.

As shown in FIG. 4A, the outer peripheral part of the die member 20-1 made of SKD61 is roughly cut so that the slit groove formation surface 400 is projected over its peripheral area (which becomes the reference surface 200).

Next, as shown in FIG. 4B, a plurality of feeding holes 31 is formed using drills in the feeding hole formation surface 300. The feeding hole formation surface 300 is the opposite surface on which the slit groove formation surface 400 is formed.

Next, as shown in FIG. 4C, each slit groove 41 is formed in the slit groove formation surface 400 of the die member 20-1 using a circular grindstone blade (not shown) in order to form the slit grooves 41 arranged in a square lattice shape.

Next, as shown in FIG. 4D, the outer periphery of the slit groove formation surface 400 of the die member 20-1 is finished in a predetermined circular shape. The circular step-shaped part 42 is formed in the central part of the slit groove formation surface 400 so that the circular step-shaped part 42 is projected in the central part of the slit groove formation surface 400. The die body part 2 of the extrusion die 1 is thereby made.

Next, the guide ring 5 and the above die body part 2 are assembled into the extrusion die 1. On fixing the guide ring 5 to the die body part 2, the guide ring 5 is placed on the reference surface 200 of the die body part 2, pins (not shown) are inserted into the pin holes (not shown) formed in the die body part 2 and the guide ring 5. At this time, a predetermined distance is maintained between the outer peripheral surface 401 of the slit groove part 4 of the die body part 2 and the inner peripheral surface 510 of the pole part 51 of the guide ring 5 in order to form the raw material feeding path 11 through which raw material is fed in order to make the outer peripheral skin 83 of the honeycomb structure 8.

The method of making the extrusion die 1 to be used for producing the honeycomb structure is thereby completed.

Next, a description will now be given of the method of producing the honeycomb structure 8 using the extrusion die 1 having the above structure.

The extrusion die 1 made by the prescribed method is set at the front end of a screw type extrusion apparatus (not shown). Raw material 80 containing ceramic raw material is mixed and then supplied into the screw type extrusion apparatus. The raw material 80 is composed mainly of raw cordierite material. The raw cordierite material is composed of kaolin, melting silica, aluminium hydroxide, alumina, and talc in a predetermined chemical composition. Water, binder, pore forming agent, and others are added to the raw cordierite material, and are then mixed in order to make the raw material 80.

Next, the screw type extrusion apparatus (not shown) extrudes the raw material 80 into the extrusion die 1. In the first embodiment, the raw material 80 is supplied into the feeding holes 31 and the feeding holes 32 for forming the outer peripheral skin 83.

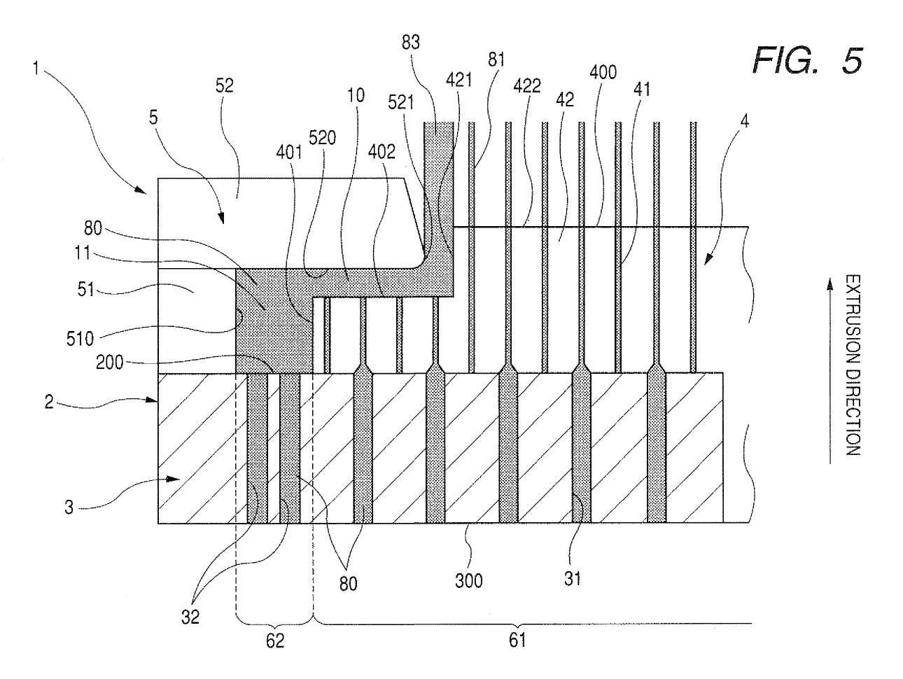

FIG. 5 is an explanatory view showing the process of extruding the raw material 80 in order to mold the honeycomb structure 8 using the extrusion die 1 according to the first embodiment shown in FIG. 1.

As shown in FIG. 5, the raw material 80 is fed from the feeding holes 32. The raw material 80 supplied through the reference surface 200 and the outer peripheral slit groove formation surface 402 then passes through the raw material feeding path 11 and the gap 10 in order, and finally forms the outer peripheral skin 83. This raw material 80 supplied through the reference surface 200 and the outer peripheral slit groove formation surface 402 is used only for forming the outer peripheral skin 83.

As shown in FIG. 5, the raw material 80 extruded through the central slit groove formation surface 422 directly forms the cell walls 81 arranged in a square lattice shape.

FIG. 6 is a perspective view of the honeycomb structure 8 as a final product which has been produced using the extrusion die 1 according to the first embodiment shown in FIG. 1.

The outer peripheral skin 83 and the cell walls 81 are simultaneously formed by using the extrusion die 1. As shown in FIG. 6, the honeycomb structure 8 is composed mainly of the cell walls 81, the cells 82 surrounded by the cell walls 81, and the outer peripheral skin 83.

An extruded ceramic green body is extruded through the extrusion die 1. The extruded ceramic green body is then dried and fired at a predetermined temperature for a predetermined length of time in order to produce the honeycomb structure 8 made of cordierite ceramic as a final product.

Next, a description will now be given of actions and effects of the extrusion die 1 according to the first embodiment of the present invention.

In the structure of the extrusion die 1 according to the first embodiment of the present invention, the feeding hole formation area 62 (as the secondary formation area) is formed at the outside area of the slit groove formation area 61(as the primary formation area) in the die body part 2 so that the feeding hole formation area 62 (as the secondary formation area) surrounds the slit groove formation area 61 (as the primary formation area). In the feeding hole formation area 62, the feeding holes 32 are formed in rows of a ring-shape arrangement. Through the feeding holes 32, the raw material 80 is supplied in order to make the outer peripheral skin 83 of the ceramic structure 8.

In particular, the extrusion die 1 according to the first embodiment of the present invention has the structure in which the raw material 80 to be used for only making the outer peripheral skin 83 is mainly supplied from the feeding holes 32 formed in the feeding hole formation area 62 which is the outside area of the slit groove formation area 61.

In the structure of the extrusion die 1 of the first embodiment, each feeding hole 32 in each ring-shaped row has a same distance (designated by the reference characters “a” and “b” as shown in FIG. 2) which is measured in the direction from the front end 521 of the guide part 52 to the center of diameter of each feeding hole 32.

According to the above structure, in order to make the outer peripheral skin 83, the raw material 80 reaches the front end 521 of the guide part 52 of the guide ring 5 from each feeding hole 32 in each ring-shaped row by an equidistant-distance movement. In other words, this structure of the extrusion die 1 of the first embodiment enables that each feeding hole 32 in each row supplies the same amount of ceramic raw material to the front end 521 of the guide part 52. It is thereby possible to suppress variation of supplying the ceramic raw material for making the outer peripheral skin 83, and to form the outer peripheral skin 83 of a uniform thickness.

As described above, using the extrusion die 1 of the first embodiment can provide the honeycomb structures 8 having the outer peripheral skin 83 of a uniform thickness with a superior thermal shock resistance and small variation to thermal stress generated by thermal shock.

### Second Embodiment

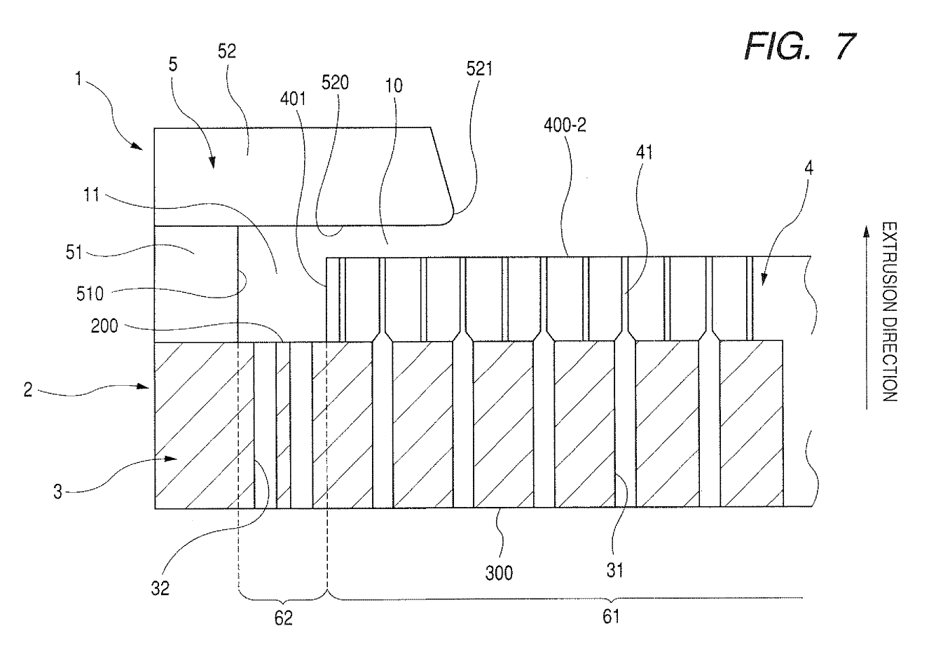

A description will be given of the extrusion die according to the second embodiment of the present invention with reference to FIG. 7.

FIG. 7 is an explanatory view showing another structure of the extrusion die for molding a honeycomb structure according to the second embodiment.

As shown in FIG. 7, in the extrusion die 1 of the second embodiment, the slit groove part 4 has the slit groove formation surface 400-2 of a flat shape, not having any step-shaped part. In other words, the slit groove part 4 in the extrusion die 1 of the second embodiment does not have the circular step-shaped part 42 of the extrusion die I according to the first embodiment.

Other components of the extrusion die 1 according to the second embodiment are the same as those of the extrusion die 1 of the first embodiment. The extrusion die according to the second embodiment of the present invention has the same actions and effects of the extrusion die of the first embodiment.

### Third Embodiment

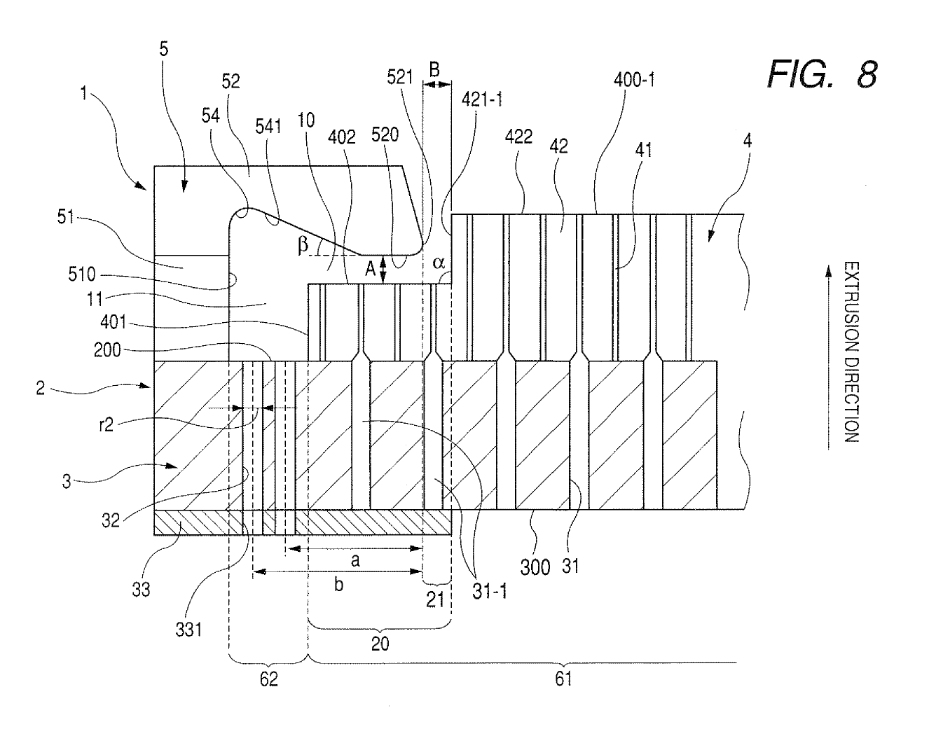

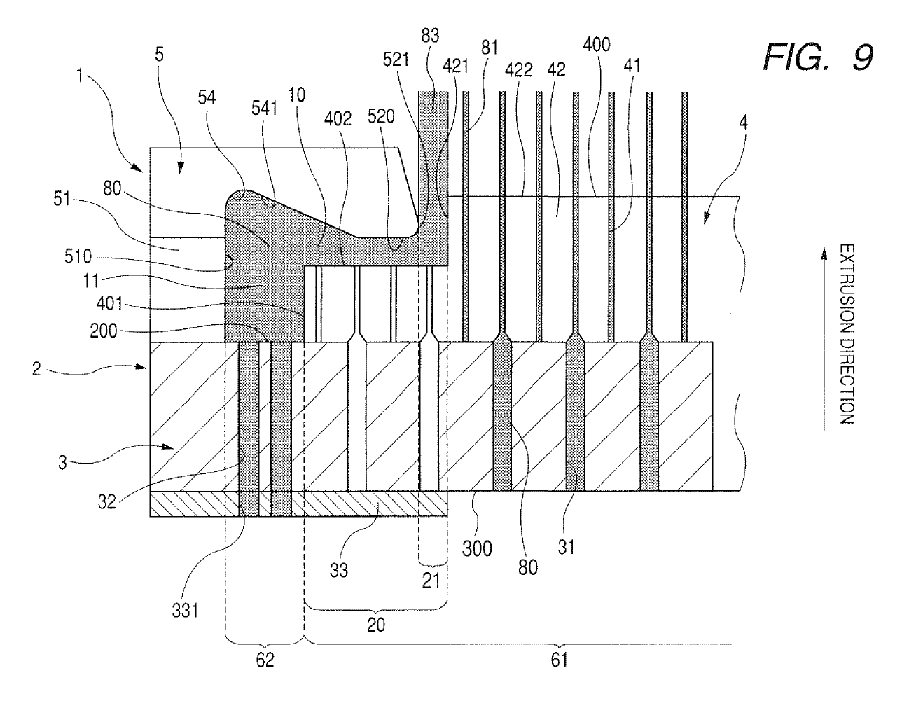

A description will be given of the extrusion die according to the third embodiment of the present invention with reference to FIG. 8 and FIG. 9.

FIG. 8 is an explanatory view showing an extrusion die for extruding and molding a honeycomb structure according to a third embodiment of the present invention.

As shown in FIG. 8, a circular step-shaped part 42-1 is so formed in the extrusion die 1 according to the third embodiment that the outer peripheral side surface 421-1 in the circular step-shaped part 42-1 is tilted to the outer peripheral slit groove formation surface 402 at angle α within a range of 90°≦α≦95°. FIG. 8 shows one example of α=90°,

The extrusion die 1 according to the third embodiment satisfies the relationship A≦B≦1.5 A, where A is the gap between the outer peripheral 30 slit groove formation surface 402 to the guide part 52 (namely, the distance measured from the outer peripheral slit groove formation surface 402 to the guide part 52), and B is the gap between the outer peripheral side surface 421-1 of the circular step-shaped part 42-1 and the front end 521 of the guide part 52 (namely, the distance in the direction vertical to the extrusion direction measured from the outer peripheral side surface 421-1 in the circular step-shaped part 42-1 to the front end 521 of the guide part 52). FIG. 8 shows one example of A=0.4 mm and B=0.55 mm.

As shown in FIG. 8, the die body part 2 has a feeding hole sealing area 20 in which the feeding holes 31-1 are sealed, through which no ceramic raw material is fed.

The feeding hole sealing area 20 includes an area 21. The outer peripheral slit groove formation surface 402 in the area 21 in the feeding hole sealing area 20 does not face the guide part 52.

In the structure of the extrusion die 1 according to the third embodiment, a sealing member 33 of a ring shape is fitted to the feeding hole formation surface 300. The sealing member 33 of a ring shape prevents the feeding holes 31-1 in the feeding hole sealing area 20 from the supply of the raw material 80. The sealing member 33 of a ring shape is so formed to seal all the feeding holes 31-1 formed in the outside area of the circular step-shaped part 42-1. In particular, the sealing member 33 of a ring shape has penetration holes 331 which are communicated with the feeding holes 32 in order to supply the raw material and to make the outer peripheral skin 83.

Still further, as shown in FIG. 8, a ring shaped pool-groove 54 is formed along the whole circumference of the inside of the guide part 52 in the guide ring 5. The ring shaped pool-groove 54 is a concave-curved part formed in the extrusion direction from the guide surface 520 toward the inner peripheral surface 510 of the pole part 51. The guide surface 520 faces the outer peripheral slit groove formation surface 402 in the slit groove part 4.

The inner surface of the ring shaped pool-groove 54 has a pool-groove slope 541. The depth of the pool-groove slope 541 is gradually decreased from the inner peripheral surface 510 toward the front end 521 of the guide part 52.

The slope angle β of the pool-groove slope 541 to the guide surface 520 is within a range of 10°≦β≦20°. FIG. 8 shows one example of β=15°.

Other components of the extrusion die according to the third embodiment are the same as those of the first embodiment.

Next, a description will now be given of the method of producing the honeycomb structure 8 using the extrusion die according to the third embodiment.

FIG. 9 is an explanatory view showing a process of extruding the raw material 80 in order to mold the honeycomb structure 8 by using the extrusion die 1 according to the third embodiment shown in FIG. 8.

At first, as shown in FIG. 9, the raw material 80 is fed into the feeding holes 31 and 32. The feeding holes 32 feed the raw material 80 for only making the outer peripheral skin 83 of the honeycomb structure 8. In the third embodiment, no raw material 80 is supplied to the feeding holes 31-1 formed in the feeding hole sealing area 20 because those feeding holes 31-1 in the area 20 are sealed by the sealing member 33.

The raw material 80 fed into the feeding holes 32 is transmitted from the reference surface 200 to the ring shaped pool-groove 54 through the raw material feeding path 11 and the gap 10, and temporarily accumulated in this ring shaped pool-groove 54.

The raw material 80 is then transmitted into the gap 10 again from the ring shaped pool-groove 54, and finally fed toward the central part of the die body part 2. The raw material 80 is then guided by the guide part 52 of the guide ring 5 in order to finally make the outer peripheral skin 83.

On the other hand, the cell walls 81 are formed in a square lattice shape by using the raw material 80 which is extruded through slit grooves 41 and the central slit groove formation surface 422.

Other steps of forming the honeycomb structure 8 are the same as those in the first embodiment.

A description will now be given of the actions and effects of the extrusion die according to the third embodiment of the present invention.

The die body part 2 of the extrusion die 1 has the circular step-shaped part 42-1 which projects in the extrusion direction prescribed above. The circular step-shaped part 42-1 is so formed that the angle α of the outer peripheral side surface 421-1 to the outer peripheral slit groove formation surface 402 takes the value within the range of 90°≦α≦95°. Therefore when the feeding direction of the raw material 80 is changed into the extrusion direction at the front end 521 of the guide part 52 and its vicinity, the structure of the outer peripheral side surface 421-1 of the circular step-shaped part 42-1 limits the flow of the raw material 80 toward the central part of the die body part 2 of the extrusion die 1 and certainly leads the change of the flowing direction of the raw material 80 in the extrusion direction. This structure of the extrusion die 1 according to the third embodiment ensures that the outer peripheral skin 83 is formed with a uniform thickness in the extrusion direction, and further prevents the outer peripheral skin 83 and/or the cell walls 81 adjacent to the outer peripheral skin 83 from being tilted.

Still further, according to the present invention, the structure of the extrusion die according to the third embodiment satisfies the relationship A≦B≦1.5 A, where A is the gap between the outer peripheral slit groove formation surface 402 and the guide part 52 (namely, the distance measured from the outer peripheral slit groove formation surface 402 to the guide part 52), and B is the gap between the outer peripheral side surface 421-1 of the circular step-shaped part 42-1 and the front end 521 of the guide part 52 (namely, the distance in the direction vertical to the extrusion direction measured from the outer peripheral side surface 421-1 of the circular step-shaped part 42-1 to the front end 521 of the guide part 52). The outer peripheral skin 83 is made using the raw material 80 which is fed through the gap 10 of the distance A and then fed through the gap between the outer peripheral side surface 421-1 of the circular step-shaped part 42-1 and the front end 521 of the guide part 52. The thickness of the outer peripheral skin 83 is determined by the magnitude of the distance B.

So long as the values A and B satisfy the above relationship, the total amount of the raw material 80 necessary to make the outer peripheral skin 83 can be supplied through the gap 10. The structure of the extrusion die of the third embodiment can supply the amount of raw material adequate to stably produce the honeycomb structure having an outer peripheral skin 83 of uniform thickness.

Still further, the die body part 2 has the feeding hole sealing area 20. No raw material 80 is fed into the feeding holes 31-1 formed in the feeding hole sealing area 20. The feeding hole sealing area 20 has at least the area 21. The outer peripheral slit groove formation surface 402 in the area 21 does not face the guide part 52.

According to the above structure of the extrusion die of the third embodiment having the structure described before, it is possible to halt the supply of the raw material 80 through the feeding holes 31-1 and the slit grooves formed in the area 21. That is, on producing the honeycomb structure 8, the outer peripheral skin 83 is made only by using the raw material 80 which is fed through the gap 10 between the die body part 2 and the guide part 52. Specifically, the raw material 80 which is fed into the gap 10 through the feeding holes 32 formed in the outside area of the area 20 is further fed toward the center direction of the die body part 2 through the inside of the gap 10. At the front end 521 of the guide part 52, the raw material 80 is prevented from flowing toward the central part of the die body part 2 by being guided by the guide part 52 in the extrusion direction.

The outer peripheral skin 83 is made under such a feeding control of the raw material 80 by the guide part 52 and the circular step-shaped part 42. The structure of the extrusion die 1 according to the third embodiment enables that the outer peripheral skin 83 is made only using the raw material 80 which is fed into the same direction. As a result, it is possible to stably make the outer peripheral skin 83 with high accuracy by using the extrusion die according to the present invention. The use of the extrusion die according to the present invention can avoid the production of the honeycomb structures having the outer peripheral skin of non-uniform thickness and a low stress resistance.

In the structure of the extrusion die according to the third embodiment, the ring shaped pool-groove 54 is formed along the whole circumference of the guide part 54 of the guide ring 5. The ring shaped pool-groove 54 is a concave curved part formed in the extrusion direction from the guide surface 520 toward the inner peripheral surface 510 of the pole part 51. The guide surface 520 faces the outer peripheral slit groove formation surface 402 in the slit groove part 4. The raw material 80 fed through the feeding holes 32 passes through the raw material feeding path 11, and flows into the ring shaped pool-groove 54 and is accumulated therein. The raw material 80 accumulated in the ring shaped pool-groove 54 then flows toward the center direction of the die body part 2. The raw material 80 is then guided in the extrusion direction by the guide part 52 of the guide ring 5. The outer peripheral skin 83 of the honeycomb structure 8 is thereby made.

That is, on using the extrusion die according to the third embodiment, the raw material 80 is temporarily accumulated in the ring shaped pool-groove 54, and then fed into the center direction of the die body part 2. The above structure of the extrusion die can realize a stable feeding state of the raw material 80, in other words, can uniform the feeding amount of, the feeding speed of, and the feeding direction of the raw material 80. It is thereby possible to decrease and suppress the thickness variation of the outer peripheral skin 83 to be as small as possible, and to provide the honeycomb structures having the outer peripheral skin 83 with superior uniform shape.

Still further, according to the third embodiment, the pool-groove slope 541 is formed in the inner surface pf the ring shaped pool-groove 54 so that the depth of the ring shaped pool-groove 54 is gradually decreased toward the front end 521 of the guide part 52. The slope angle β of the pool-groove slope 541 to the guide surface 520 is within a range of 10°≦β≦20°. The pool-groove slope 541 formed in the ring shaped pool-groove 54 having the slope angle β within a range of 10°≦β≦20° can gradually apply the pressure to the raw material 80. It is thereby possible to supply the raw material 80 with a high density toward the center direction of the die body part 2 and also to make the outer peripheral skin 83 with high accuracy.

Other actions and effects of the extrusion die according to the third embodiment are the same as those of the extrusion die according to the first embodiment.

### Other Effects of the Present Invention

In the extrusion die according to the present invention, the extrusion direction is the direction to which the raw material 80 is extruded through the extrusion die. The slit groove formation surface is the surface 400, 400-1 in which the slit grooves 41, 41 are formed. Further, it is possible to adopt various shapes such as a triangle shape, a square shape, and a hexagonal shape as the lattice shape of the slit grooves 41 according to the shape of the cell walls in the honeycomb structure.

In the explanation of the embodiments of the present invention prescribed above, in addition to the raw material 80 supplied from the feeding holes (as the secondary feeding holes) formed in the feeding hole formation area 62 (in the secondary formation area), the raw material is also supplied through the slit grooves 31 formed in the slit groove formation area 61 (as the primary formation area) which faces the guide part 52 as shown in FIG. 2. In this case, the more the supply of the raw material through the feeding holes 32 (as the secondary feeding holes) is increased when compared with that from the feeding holes 31 which face the guide part 52 of the guide ring 5, the more the outer peripheral skin 83 of a cylindrical shape is accurately formed. That is, the structure of the extrusion die according to the present invention provides the superior effects for producing the honeycomb structure having the outer peripheral skin of a uniform thickness with superior thermal shock resistance.

Still further, it is possible to supply the raw material for the outer peripheral skin only through the feeding holes 32 formed in the feeding hole formation area 62 (as the secondary formation area). For example, as shown in FIG. 8, it is possible to seal the feeding holes 31-1 which face the guide part of the guide ring 5 by the sealing member 33 in order to stop the supply of the raw material 83. This structure of the extrusion die according to the present invention also provides the superior effects for producing the honeycomb structure having the outer peripheral skin of a uniform thickness with superior thermal shock resistance.

In the extrusion die as another aspect of the present invention, it is preferable that an inner diameter of each secondary feeding hole is equal to or more than that of each primary feeding hole.

The above structure of the extrusion die enables the feeding holes 32 (as the secondary feeding holes) to be easily formed in the feeding hole formation area 62 (as the secondary formation area) in the die body part 2. Using the extrusion die having the above structure can make the outer peripheral skin with a uniform thickness without variation of the raw material supply.

In the extrusion die as another aspect of the present invention, it is preferable that an inner diameter of each secondary feeding hole is within a range of 0.7 mm to 1.8 mm.

This structure of the extrusion die also enables the feeding holes 32 (as the secondary feeding holes) to be easily formed in the feeding hole formation area 62 (as the secondary formation area) in the die body part 2. Using the extrusion die having the above structure can also make the outer peripheral skin with a uniform thickness without variation of the raw material supply.

When the inner diameter of each secondary feeding hole is less than 0.7 mm, there is a possibility of not adequately supplying the raw material because of increasing a pressure loss in the secondary feeding holes. On the other hand, when the inner diameter of each secondary feeding hole exceeds 1.8 mm, there is a possibility of being difficult to adjust the feeding amount of or the supply amount of the raw material.

In the extrusion die as another aspect of the present invention, it is possible that the slit groove formation surface of the die body part in the primary formation area is flat, and the slit grooves are formed in the slit groove formation surface.

In the extrusion die as another aspect of the present invention, it is possible that the slit groove formation surface of the die body part in the primary formation area in which the slit grooves are formed has a step-shaped part which projects in the extrusion direction and does not face the guide part of the guide ring.

According to the extrusion die of the present invention having the above structure, it is possible to suppress the feeding or supplying variation of the raw material. Using the extrusion die according to the present invention can make the outer peripheral skin with a uniform thickness without variation of the raw material supply.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. An extrusion die to be used for producing a honeycomb structure comprising a plurality of cell walls arranged in a honeycomb shape, a plurality of cells surrounded by the cell walls, and an outer peripheral skin covering an outer peripheral surface of the honeycomb structure, the extrusion die producing the cell walls and the outer peripheral skin as one body, comprising:
a die body part comprising:
a primary formation area in which primary feeding holes and slit grooves are formed in a lattice shape arrangement and raw material is fed from the primary feeding holes into the slit grooves correspondingly communicated with the primary feeding holes; and
a secondary formation area placed in the outside of the primary formation area, and in the secondary formation area a plurality of secondary feeding holes are formed in at least one or more ring-shaped rows, through the secondary feeding holes, raw material is fed in order to form the outer peripheral skin, and each secondary feeding hole in each row has a same length, in a direction vertical to the extrusion direction of the raw material, which is measured from each secondary feeding hole to a front end of a following guide ring,
and the guide ring comprising:
a pole part formed on the die body part toward an extrusion direction of the raw material in the extrusion die; and
a guide part formed from the pole part toward in an inside direction of the die body part so that a gap is formed between the guide part and the die body part.

2. The extrusion die according to claim 1, wherein an inner diameter of each secondary feeding hole is equal to or more than that of each primary feeding hole.

3. The extrusion die according to claim 1, wherein an inner diameter of each secondary feeding hole is within a range of 0.7 mm to 1.8 mm.

4. The extrusion die according to claim 2, wherein an inner diameter of each secondary feeding hole is within a range of 0.7 mm to 1.8 mm.

5. The extrusion die according to claim 1, wherein a slit groove formation surface of the die body part in the primary formation area is flat, and the slit grooves are formed in the slit groove formation surface.

6. The extrusion die according to claim 2, wherein a slit groove formation surface of the die body part in the primary formation area is flat, and the slit grooves are formed in the slit groove formation surface.

7. The extrusion die according to claim 3, wherein a slit groove formation surface of the die body part in the primary formation area is flat, and the slit grooves are formed in the slit groove formation surface.

8. The extrusion die according to claim 1, wherein a slit groove formation surface of the die body part in the primary formation area, in which the slit grooves are formed, has a step-shaped part which projects in the extrusion direction and does not face the guide part of the guide ring.

9. The extrusion die according to claim 2, wherein a slit groove formation surface of the die body part in the primary formation area, in which the slit grooves are formed, has a step-shaped part which projects in the extrusion direction and does not face the guide part of the guide ring.

10. The extrusion die according to claim 3, wherein a slit groove formation surface of the die body part in the primary formation area, in which the slit grooves are formed, has a step-shaped part which projects in the extrusion direction and does not face the guide part of the guide ring.

11. The extrusion die according to claim 8, wherein an outer peripheral side surface of the step-shaped part is tilted to the slit groove formation surface of the die body part at an angle a within a range of 90°≦α≦95°.

12. The extrusion die according to claim 8, wherein the guide ring and the die body part satisfies a relationship of A≦B≦1.5 A, where A is a gap between the guide part and the slit groove formation surface of the die body part, and B is a gap between an outer peripheral side surface of the step-shaped part of the die body part and the front end of the guide part of the guide ring.

13. The extrusion die according to claim 8, wherein a pool groove is formed in the inside of the guide part of the guide ring, and the pool groove has a slope which gradually rises toward the front end of the guide part, and an angle β of the slope of the pool groove to the front end of the guide ring is within a range of 10≦β≦20°.

14. The extrusion die according to claim 8, wherein the primary feeding holes other than the primary feeding holes formed in the step-shaped part in the primary formation area are sealed in order to halt the supply of the raw material.
